(19) United States
(12) Patent Application Publication
(10) Pub. No.: US 2014/0225745 A1
(43) Pub. Date: Aug. 14, 2014

(54) TELEMETRY SYSTEM FOR WATER CONSUMPTION

(71) Applicant: Mustapha Lakhdari, Tipasa (DZ)

(72) Inventor: Mustapha Lakhdari, Tipasa (DZ)

(21) Appl. No.: 14/350,571

(22) PCT Filed: Oct. 9, 2012
(86) PCT No.: PCT/DZ2012/000004

§ 371 Date: Apr. 9, 2014

(30) Foreign Application Priority Data
Oct. 9, 2011 (DZ) 110691

(51) Int. Cl. G01D 4/00; G01F 3/06

(52) U.S. Cl. CPC G01D 4/002; G01F 3/06
USPC 340/870.02

(57) ABSTRACT

The invention relates to a telemetry system for collecting tap-water consumption measurements in real time through a self-powered electromechanical device that can be integrated inside the tap or provided as an outer module capable of being adapted to the outlet of any type of tap. The electromechanical device automatically or manually adjusts the water flow rate, and indicates the volume of water to be used, displays the consumption measurements on a display in real time, and sends the measurements to a storage device in order to store same in an external module and analyze same with a view to defining excessive consumers, losses, leaks, etc., and sharing the information, via the Internet, with other users in the region and vice versa. The system can be used for improving host analysis and water management and distribution capabilities.

### TECHNICAL FIELD TO WHICH THE INVENTION RELATES

The present invention is a system of telemetry and display for water consumption and regulating water flow to faucets. This invention can be used in the hydraulic field, in the water distribution systems and more particularly to faucets, valves and domestic consumption.

### State of the Art Previous:

There are many products on the market to reduce the water flow, or to measure the water consumption, In general, it is water meter with standard features, which does not fulfill certain specific needs (measurement of consumption on real-time, storage of measures, detection of leaks and excessive consumption, . . . etc.).

### Purpose of the Invention:

The invention is primarily intended for reduce water consumption through of an electromechanical system which allows the user to know its patterns of consumption and correct excessive consumption by the use of an electromechanical device of automatic regulation which integrates to a valve or faucet.

### ENUNCIATED OF FIGURES

The accompanying figures give, as non-limiting examples, a schematic description of the invention:

FIG. 1 is a general schema of the system,

FIG. 1a is a schema of the external module adapted to the output of faucet

FIG. 2 is a longitudinal section of the mechanical part of the electromechanical device of the system.

FIG. 2a is a right view of the mechanical part of the electromechanical device of the system.

FIG. 2b is a top view of the mechanical part of the electromechanical device of the system.

FIG. 2c is a front view of the mechanical part of the electromechanical device of the system.

FIG. 2d is a rear view of the mechanical part of the electromechanical device of the system.

FIG. 3 is a front perspective view of the mechanical part of the electromechanical device of the system with the motor and dynamo.

FIG. 3a is a perspective rear view of the mechanical part of the electromechanical device of the system with the motor and dynamo.

FIG. 4 is a schema of the electronic part of the electromechanical device of the system.

### PRESENTATION OF THE ESSENCE (SUBSTANCE) OF THE INVENTION

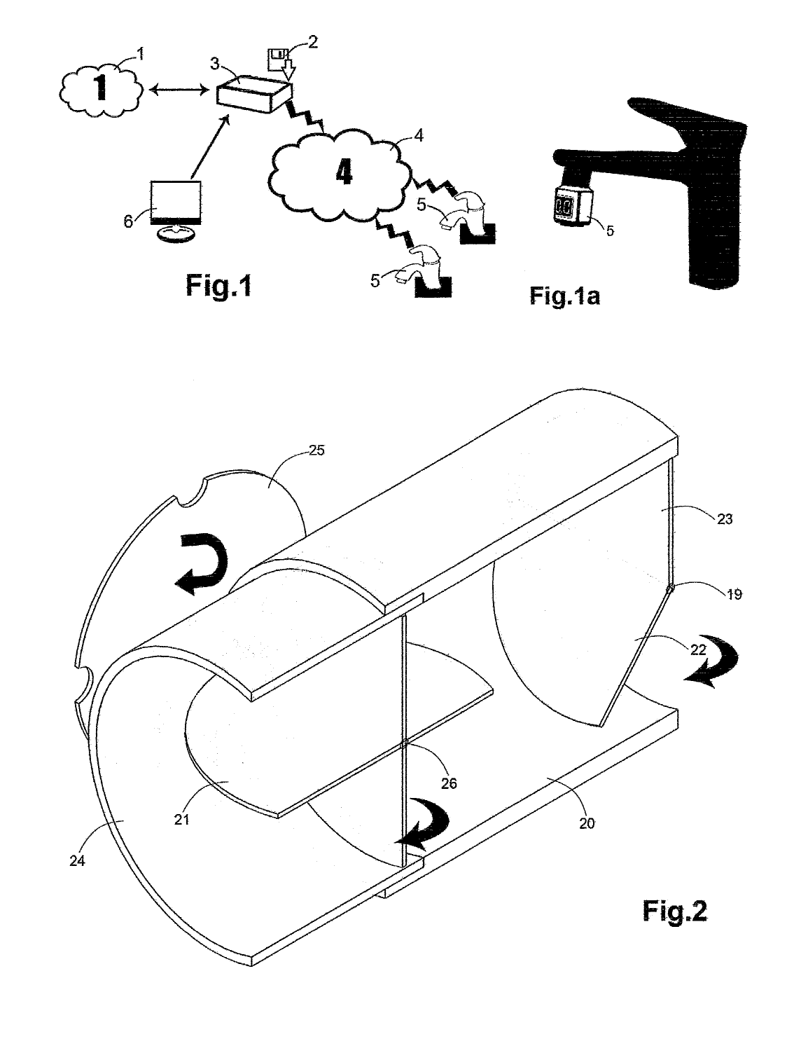

On FIG. 1, there are electromechanical devices (5) connected by a wireless communication network (4) (Bluetooth, ZigBee, Wi-Fi, etc.) to an electronic device for storage and analysis (3), comprising an external storage medium (USB, SD Memory Card, etc.) the storage device (3) is connected to a screen (6) and connected to the Internet (1).

The electromechanical device (5) can be integrated within a faucet or as an external module that adapts at the spout's end of all types of faucets, as shown in FIG. 1a.

The electromechanical device (5) is responsible for the automatic opening of the faucet, controlling the water flow, measuring and displaying water consumption, and sending water consumption measures via the wireless network (4) to device (3).

The device (3) contains a processor, a radio transceiver and an external storage medium (2), and can be connected to the screen (6) and a keyboard.

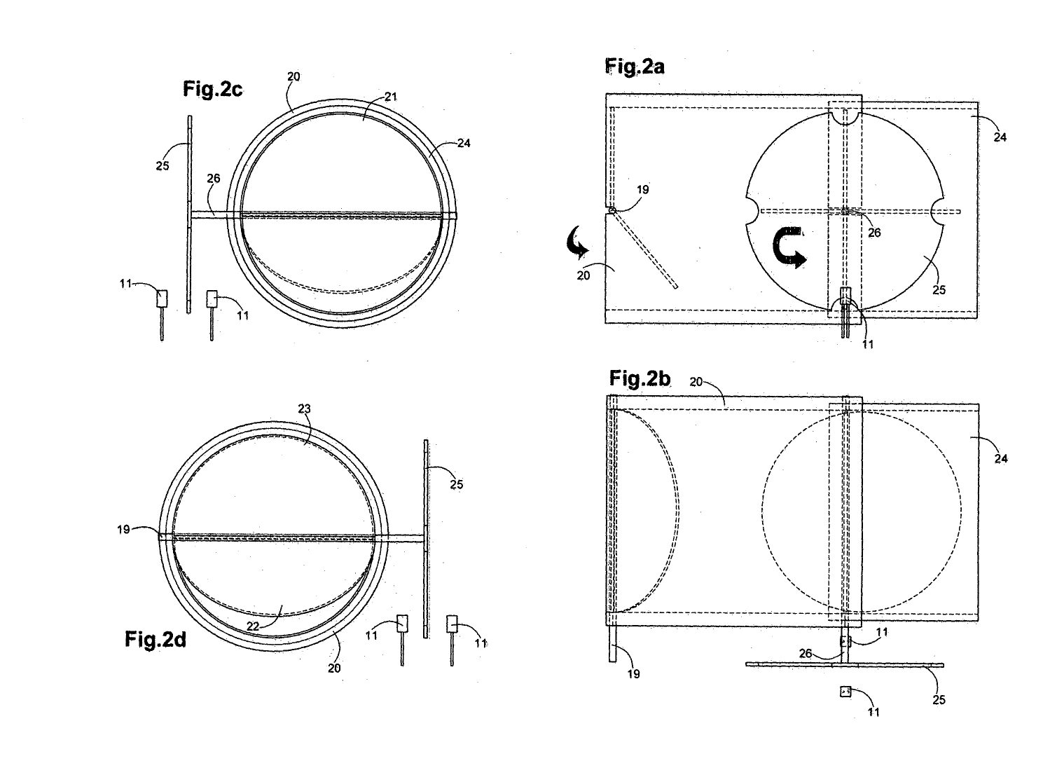

In the mechanical part of the electromechanical device (5) shown in FIG. 2 has two tubes (20) and (24), a part of the tube (24) penetrates into the tube (20) to set the axis (26), and two semi-cylinders are also observed inside tube (20): the first semi-cylinder (23) is set vertically and the second semi-cylinder (22) is set and rotates on axis (19) attached to the tube (20).

The waterwheel (21) mounted with the gear (25) by the axis (26), which connects the two, inside tube (24).

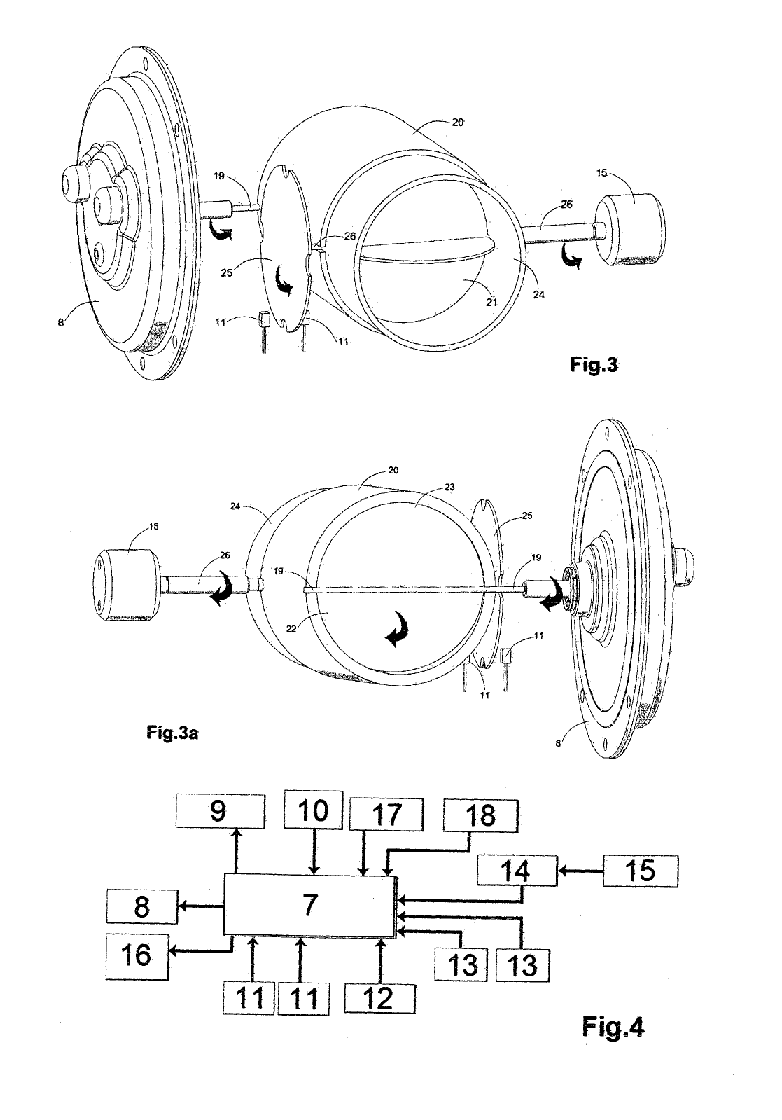

In FIG. 3, the waterwheel (21) is connected with the electric dynamo (15) and the gear (25) by the axis (26). The two infrared sensors (11) (a transmitter and a receiver) placed at the same level of the perforations located on the rim of the wheel (25).

In FIG. 3A, the electronic motor (8) and the semi-cylinder (22) are connected by the axis (19). The motor (8) could be linked to the axis (19) through the gears.

The motor (8) rotates the semi-cylinder (22), responsible for opening the tube (20) so that the water flows below the semi-cylinder (23). Thus, by controlling the degree of rotation of the semi-cylinder (22) the degree of opening of the tube (20) is controlled, consequently the amount of water passing through the electromechanical device (5).

By flowing below the semi-cylinder (22), without exceeding the middle level, the water will exert a pressure that will turn the waterwheel (21). The waterwheel (21) rotation speed will depend on the water flow.

The wheel (25) and the dynamo (15) turn at the same time as the waterwheel (21) and at the same speed.

The rotation of the wheel (25) will activate and cut off the signal between the two infrared sensors (11) according to its passage through the perforations, which gives the number and the exact degree of rotation of the wheel (25) and the waterwheel (21), showing in the same time the value of the water flow.

In the electronic part of the electromechanical device (5) shown in FIG. 4, a processor (7) connected with infrared sensor (10) (hands and presence detector), a display (9), a radio transceiver (16), motor (8), two infrared sensors (11) (a transmitter and a receiver), and other two infrared sensors (13) (hands detector), two push buttons (17) and (18), a camera (12), and a rechargeable battery (14) hooked up to the dynamo (15).

There are various methods used in the infrared sensors (10) and (13) to detect hands: sensors operating by the sensitivity to the human body's temperature or by a transceiver by signal collision with the hand and return towards the receiver.

The dynamo (15) will produce electrical energy and charge the battery (14) which supply the electronic part of the system.

When the infrared sensor (10) detects a human body (e.g., a hand), it sends a signal to the processor (7) that starts the motor (8). This rotates the half cylinder (22) and opens the electromechanical device (5)—with a precise degree—to allow water to start flowing. The processor (7) then receives a signal from two infrared sensors (11) each time the signal passes between them with the rotation of the wheel (25). The processor (7) calculates the speed of rotation of wheel (25) by counting the number of signal interruptions between the two infrared sensors (11) in time—this in turn defines the flow rate of the water passing through the electromechanical device (5).

The processor (7) controls the motor (8) and calculates the flow rate of water passing through the electromechanical device (5) (by determining the speed of rotation of the wheel 25). When it reaches the required flow rate, it stops the motor (8). It therefore accurately adjusts the semi-cylinder (22) position to regulate the flow of water passing through the electromechanical device (5).

In order to manually adjust the flow of water from the electromechanical device (5), there are two infrared sensors (13) of which one is placed on the right and the other on the left. If a hand placed on the right hand side of the electromechanical device (5), the infrared sensor (13) located on the right will detect it's presence and transmit a signal to the processor (7) which in turn will action the motor (8) and increase degree of rotation of the semi-cylinder (22). This will increase the size of the opening, thus increasing the flow rate of the water passing through the electromechanical device (5). The same process occurs for the infrared sensor (13) positioned on the left hand side in order to reduce the flow rate of the water.

The processor (7) calculates the amount of water passing through the electromechanical device (5) by multiplying the flow rate of water with the time.

During each use, this value is shown on the display (9) in real time in order to allow the user to monitor their consumption.

For each new use of the device, the display (9) will indicate an initial value of ‘0’.

The user can pre-define the required volume of water to be released by the electromechanical device (5) by pressing the button (17). When doing so, the processor (7) add ‘0.1’ to the value shown on the display (9) and if it's empty the value will be ‘0’. Similarly, when the user presses button (18), the processor (7) subtracts ‘0.1’ from the value shown on the display (9). In order to increase or decrease the value faster, the user needs to remain pressing on either buttons (17) or (18).

After a few seconds, if the value shown on the display (9) has not changed, the water will start to flow and the processor (7) subtracts the volume of water released by the electromechanical device (5) from the value shown on the display (9). The display (9) will show the updated value until it reaches ‘0’, which in turn stops the flow of water. However, it is possible to add an additional button signaling the processor (7) to start the flow of water. It is worth noting that the value shown on the display (9) is in liters.

When the user removes their hands, the infrared sensor (10) will immediately detect the absence, resulting in the processor (7) signaling the motor (8) to close the electromechanical device (5), thus stopping the flow of water.

For each use of the electromechanical device (5), the camera (12) takes an image of the user's face. The processor (7) sends the image via radio transceiver (16) along with the total volume of water used through the network (4) to the storage device (3) which will save both the consumption and corresponding image for each user of the electromechanical device (5).

The water consumption data will be treated and analyzed by the processor of device (3), taking in consideration several parameters:

The weather (geographical region)

The number of the residents

The device's aim of use (for personal purpose such as kitchen, bathroom, agricultural work)

The personal habits (historical consumption)

The user's identity (facial recognition through the photo already taken)

. . . etc

Where any other information that can be used in the consumption measurements analysis.

The user can introduce his information by using the keyboard and the screen (6), and configure the electromechanical device (5) to control the settings through the device (3).

One storage device (3) can use several electromechanical devices (5).

By the help of consumption measurements analysis, the device (3) will present a new water flow regulation (by changing the degree of rotation of the motor (8)) on the electromechanical device (5), through the radio emitter-receptor (16), in the aim that the processor (7) can use it after that apply it for the new use of the system.

The operation of water flow calculation depends on the approach between the usual use of the flow and the ideal use of the flow, until attending the ideal flow.

Also by the help of consumption measurements analysis, the device (3) calculates the ideal consumption (real needs) of a precise period of time, and it compares those ideal data with total real consumption of the same period.

The total of consumption can be by one tap (the electromechanical device (5)) or several of them, it depends on the use of the tap, that is because of the average consumption differs depending on the use (Kitchen, shower, toilets . . . ).

The real consumption is calculated basing on the previous parameters, to identify if the approach is real or far from the real needs and the precise quantity.

The device (3) will display on the screen (6) the user's consumption statistics and leak alarms, the water prodigality alarm, and the suggestions where the improvement can be done.

The analysis of the data relative to the consumption of multiple users will lead to acquire consumption data of each user by the use of the facial recognition with the time of use of the use of the device (5). That allows us to define the excessive consumers and to analyze the consumers tendency. In the same way to schedule a rational way of water consumption.

If a system user accept to share the water consumption data on the internet 1 with other users in his area and vice-versa, this will improve reception data analysis, thus because of the follow of actually tendencies.

In the case of the device (3) is not connected to the internet, the data can be transferred by the external storage support (2).

According to the system generalization, the company which hold the water management and the supply in an area or a city, receive the information about water consumption from the device (3), which is connected to the internet, thus to know the real consumption and the real needs of each house (which have in several device (3) and electromechanical device (5)) or of all the area, that what allows to improve the water supply management in the area.

What is claimed is:

1. A telemetry system for water consumption of faucets, storage and analysis of consumption for define losses, prodigality and excessive consumer and share the data related to the consumption of water with others by Internet; by integrating the electromechanical device which has a autonomy, a display of water consumption in real time and automatic or manual regulation of water flow and specifying the quantity of water.

2. The system of claim 1, characterized by telemetry water consumption of faucets in real time by integrating the electromechanical device (5) that contains a radio transceiver (16) and sending the consumption measurements to the storage device (3).

3. The system of claim 1, characterized by storage of measures water consumption in the storage device (3) via the external storage medium (2), which allows transporting manually them in the absence of internet.

4. The system of claim 1, characterized by consumption analysis compared to the system user via facial recognition of his picture taken by the camera (12) and its time to use the electromechanical device (5). This defines losses, prodigality and excessive consumers.

5. The system of claim 1, characterized by calculation of the real consumption and compared to the ideal consumption, to identify whether it is near or far from the real needs and specified it in quantity, by the display of device (3) on the screen (6) the consumption statistics of home users.

6. The system of claim 1, characterized by sharing of data on water consumption via internet with other household that used the same system vice versa for the region and with the company that makes the management and distribution of water in the region or city. Which will improve the management and distribution of water in the region by knowing the real consumption of each household in real time.

7. The system of claim 2, characterized by the presence of the electromechanical device (5), autonomy, a display of water consumption in real time and automatic or manual regulation of water flow and indicate quantity of water, and the external or internal integration to the faucet.

8. The device of claim 7, characterized by the fact of autonomy supply of electric power through the battery (14), which is powered from the dynamo (15) which rotates with the waterwheel (21) under the effect of the water pressure.

9. The device of claim 7, characterized by display of water consumption in real time on the display (9).

10. The device of claim 7, characterized by the automatic regulation of water flow based on the mechanism of the opening control on the electromechanical device (5) by the motor (8) and calculating at the same time the water flow by the number of rotations of the wheel (25).

11. The device of claim 7, characterized by the manual regulation of water flow by detecting the position of the hand of the user relative to the electromechanical device (5) (right or left) and that through the two infrared sensors (13) that allowing increase or decrease the water flow.

12. The device of claim 7, characterized by the specification of the quantity of water to be used, by the introduction of the initial value via the two buttons (17) and (18).

13. The device of claim 7, characterized by inner integration to the faucet or external module that fits of the output all type of faucet.
